(19) United States
(12) Patent Application Publication
(10) Pub. No.: US 2015/0100810 A1
(43) Pub. Date: Apr. 9, 2015

(54) ADAPTIVE POWER-DOWN OF DISK DRIVES BASED ON PREDICTED IDLE TIME

(71) Applicant: LSI CORPORATION, San Jose, CA (US)

(72) Inventors: Dipu Sreekumaran, Bangalore (IN); Arun Chandrashekhar, Bangalore (IN)

(73) Assignee: LSI CORPORATION, San Jose, CA (US)

(21) Appl. No.: 14/173,509

(22) Filed: Feb. 5, 2014

(30) Foreign Application Priority Data
Oct. 9, 2013 (IN) 1167/KOL2013

(51) Int. Cl. G06F 1/32

(52) U.S. Cl. CPC G06F 1/3268
USPC 713/324

(57) ABSTRACT

Systems and methods presented herein provide a storage system that adaptively powers-down one or more disk drives based on the predicted idle time of each disk drive. One embodiment includes a storage controller that includes a processor operable to track idle durations of the disk drive. When an idle duration ends, the processor associates the idle duration with a time window that includes that idle duration. Each time window is associated with a number of previous idle durations of the disk drive. Upon detection of a current idle duration, the processor identifies a time window with the highest number of previous idle durations of the disk drive. Then, the processor determines whether a maximum time associated with the identified time window exceeds a predetermined threshold. When the maximum time exceeds the predetermined threshold, the processor powers-down the disk drive.

This document claims priority to Indian Patent Application No. 1167/KOL/2013 (filed on Oct. 9, 2013) entitled ADAPTIVE POWER-DOWN OF DISK DRIVES BASED ON PREDICTED IDLE TIME, which is hereby incorporated by reference.

### FIELD OF THE INVENTION

The invention generally relates to power management of storage devices.

### BACKGROUND

In a variety of electronic systems, a controller may direct a storage device to power-down in order to conserve energy when the storage device is inactive. This powered-down state, sometimes referred to as “spin-down,” typically occurs after an expiration of a fixed timeout value. However, fixed timeouts often cause storage devices to spin-down too early (i.e., the storage device was likely about to enter an active state) or too late (i.e., the storage device was likely to be inactive for much longer than the timeout).

### SUMMARY

Systems and methods presented herein provide a storage system that adaptively powers-down one or more disk drives based on the predicted idle time of each disk drive. One embodiment includes a storage controller that includes an interface operable to communicatively couple the storage controller with a disk drive. The storage controller further includes a processor. The processor is operable to track idle durations of the disk drive. When an idle duration ends, the processor associates the idle duration with a time window that includes the idle duration. The time window is one of a number of time windows and each time window is associated with a number of previous idle durations of the disk drive. Upon detection of a current idle duration, the processor identifies a time window with the highest number of previous idle durations of the disk drive. Then, the processor determines whether a maximum time associated with the identified time window exceeds a predetermined threshold. When the maximum time exceeds the predetermined threshold, the processor powers-down the disk drive.

The various embodiments disclosed herein may be implemented in a variety of ways as a matter of design choice. For example, the embodiments may take the form of computer hardware, software, firmware, or combinations thereof. Other exemplary embodiments are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of a storage system employing an exemplary storage controller configured to predict disk drive idle time.

FIG. 2 is a flowchart of an exemplary method for of the storage controller of FIG 1.

FIG. 3 is a table illustrating an exemplary history of idle durations of a storage device.

FIG. 4 is a table illustrating an exemplary history of idle durations with weighted values based on a current idle duration.

FIG. 5 illustrates a computing system in which a computer readable medium provides instructions for performing methods herein.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

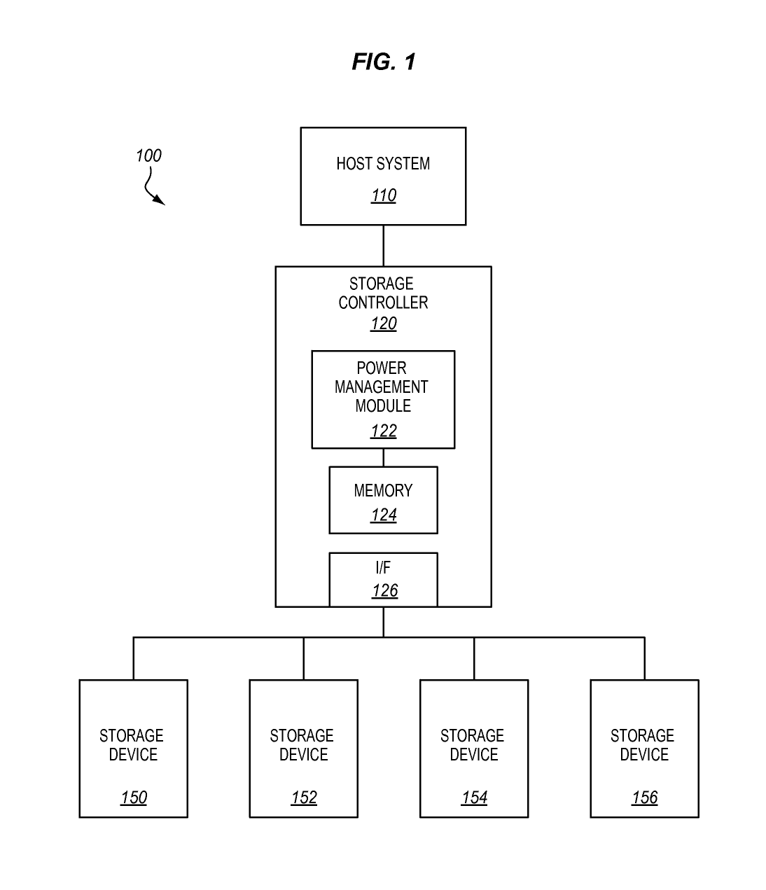

FIG. 1 is a block diagram of an exemplary storage system 100 enhanced to adaptively power-down, sometimes referred to as spin-down, one or more storage devices 150-156 based on the predicted idle time of each storage device 150-156. Storage system 100 includes a storage controller 120 that is coupled to a host system 110 and one or more storage devices 150-156. Host system 110 is operable to read from and write to the storage devices 150-156 via storage controller 120. Storage controller 120 includes any suitable computing device operable to process input/output (I/O) commands received from host system 110 and directed towards storage devices 150-156. Storage controller 120 is enhanced with power management module 122 that tracks and stores idle periods of storage devices 150-156 so that power-down decisions can be based on both the current idle time and past idle behavior. In this way, storage controller 120 can update and re-evaluate decision-making factors multiple times during an idle duration, which allows for accurate idle time prediction and quick adaption to changes in behavioral patterns of storage devices 150-156.

Storage controller 120 may comprise an independent device, a Host Bus Adapter (HBA) of a host, an integrated component of a host, an integrated component of a storage device, or some combination thereof. Furthermore, storage controller 120 may be implemented as custom circuitry, as a special or general purpose processor executing programmed instructions stored in an associated program memory, or some combination thereof. Therefore, while shown as a single, independent device in FIG. 1, the implementation of storage controller 120 is not so limited.

Storage controller 120 may also include a front-end interface (not shown) adapted to couple with host system 110 and a back-end interface 126 adapted to couple with storage devices 150-156. Back-end interface 126 and front end interface may communicate with storage devices 150-156 and host system 110 using of a variety of protocols, for example, SAS, Serial Advanced Technology Attachment (SATA), Fibre Channel, SCSI, etc. Storage controller 120 may be part of a host system and communicate with its attached host via various bus protocols, such as Peripheral Component Interconnect Express (PCIe), PCI-Extended (PCI-X), etc. Therefore, one skilled in the art will recognize that the protocols and busses used to implement storage controller 120 are merely a matter of design choice.

Host system 110 may be any suitable computing device/system including, for example, servers, workstations, PCs, etc. Memory 124 comprises any system, component, or device that is able to store data for access, such as idle time information of storage devices 150-156. Some examples of memory 124 include, Random Access Memory (RAM), Non-Volatile (e.g., flash or NVRAM) memory, Magnetic (e.g., MRAM) memory, etc. Storage devices 150-156 may comprise magnetic hard disks, solid state drives, optical media, etc. compliant with protocols for SAS, Serial Advanced Technology Attachment (SATA), Fibre Channel, etc. Although FIG. 1 illustrates four storage devices, one skilled in the art will understand that storage controller 120 may couple any number of storage devices with one or more hosts. Thus, the particular arrangement, number, and configuration of components described herein is exemplary and non-limiting.

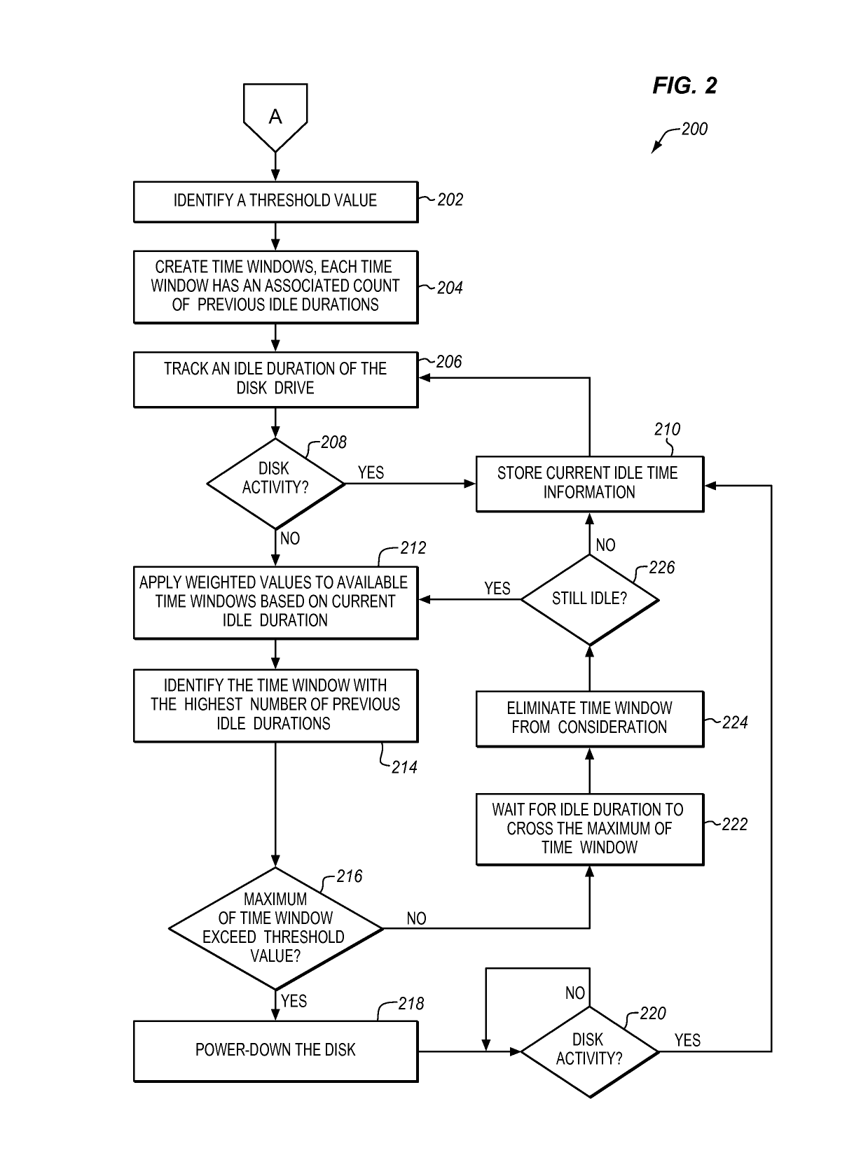

Discussion of the storage controller 120 will now be directed to the flowchart of FIG. 2. The steps of the flowchart described herein are not all inclusive and may include other steps not shown. The steps described herein may also be performed in an alternative order. Furthermore, while the steps are described with respect to a single storage device, storage controller 120 may perform the steps described herein on multiple storage devices in an independent and/or simultaneous fashion. For the sake of simplicity, the steps herein will be described with respect to storage device 150.

FIG. 2 is a flowchart describing an exemplary method 200 for adaptive power-down of a storage device 150 based on the predicted idle time of the storage device 150. At step 202, storage controller 120 identifies a threshold value. The threshold value is a length of time that storage controller 120 uses to outperform fixed timeout techniques. For instance, in a fixed timeout technique, the threshold (i.e., a timeout) is a value that triggers a power-down when the idle duration of a disk exceeds the timeout value. However, as described in further detail of the method 200 below, storage controller 120 is operable to predict whether a current idle time is likely to last longer than the threshold, and if so, can direct a power-down of storage device 150 well in advance of the current idle time reaching the threshold value. In this way, method 200 outperforms fixed timeout techniques since energy is not wasted on an inactive device that is waiting for the threshold value to be passed before it is powered-down.

The threshold value may be set by a user of the storage system 100, stored in a memory location of storage device 150, and/or stored in memory 124 of storage controller 120. Furthermore, the threshold value may be assigned to a single storage device (e.g., storage device 150) or alternatively associated with multiple storage devices (e.g., storage devices 150-156). For example, a threshold value may be assigned to all storage devices with one or more common characteristics (e.g., same model, shared interface, etc.). Furthermore, storage controller 120 may be operable to discover a timeout value that is associated with system/device(s) that employ fixed timeout power-downs and use that timeout value as the threshold value in the described method 200 to improve system power efficiency.

At step 204, storage controller 120 creates a plurality of time windows. Each time window has an associated idle count, which is the number of times storage device 150 had a previous idle duration that ended within the bounds of the start point and end point of that time window. As will be further described below, storage controller 120 is operable to compare time windows such that periods of time that are likely to include future idle durations can be identified. For instance, when it is determined that a current idle duration of storage device 150 is likely to last for a long time, storage controller 120 can anticipate the long duration and power-down storage device 150 early to save power. In one embodiment, storage controller 120 creates time windows by dividing a continuous length of time into multiple consecutive, non-overlapping time windows. The length of each time window may be set and/or adjusted by a user to achieve desired results and/or improve accuracy of idle time prediction.

Then, at step 206, storage controller 120 tracks an idle duration of storage device 150. An idle duration is any amount of consecutive time that storage device 150 remains inactive. Storage device 150 is active when it receives I/O commands, and therefore is inactive for the amount of time between any two I/O commands. In one embodiment, storage controller 120 tracks idle durations with a timer that starts after an I/O command has been received by storage controller 120 or storage device 150.

A determination is made, at step 208, as to whether storage device 150 remains in an inactive state or, alternatively, becomes active. When storage device 150 becomes active, storage controller 120 stores information related to the idle duration that was just ended by the activity at step 210. Then, the method 200 returns to step 206 and the next idle duration is detected and tracked. The stored information related to the idle duration includes, but is not limited to, the total lapsed time of the idle period, the time window that includes that lapsed time, and the total count of the number of idle periods in that time window. Information relating to a current idle duration may be stored and/or updated in memory 124 or in one of storage devices 150-156.

At step 212, weighted values are applied to the idle count of each time window. The amount of weight applied to an idle count is based on the proximity of each time window to the current idle duration. For instance, storage controller 120 may apply a higher weighted value to the idle count of those time windows closer to the current idle duration. As will be described in more detail in the examples below, application and/or adjustment of the weighted values can alter power-down decisions of storage controller 120 such that storage device 150 is powered-down more aggressively or less aggressively. In this way, a user and/or storage controller 120 may alter one or more weighted values to achieve a desired result (i.e., a desired number of power-downs over a given period) or to improve accuracy of the predicted idle times. However, it will be appreciated that, in some embodiments, no weighted value or the same weighted value is applied to the idle count of each time window.

At step 214, storage controller 120 identifies the time window with the highest number of previous idle durations. In other words, storage controller 120 identifies the time window with the highest associated idle count, described above. In embodiments with weighted values applied to the idle count of each time window, storage controller 120 identifies the time window with the highest associated idle count taking into account the multiplication/alteration to the idle counts as a result of the applied weighted values.

Then, at step 216, storage controller 120 determines whether the maximum time of the time window identified in step 214 exceeds the threshold value that was identified in step 202. The maximum time of a time window is the largest amount of time that is within the bounds of the start point and the end point of a time window. When the maximum time of the time window exceeds the threshold value, storage device 150 is powered-down at step 218. Storage device 150 remains powered-down until disk activity is detected at step 220, at which point, information relating to that idle duration is stored at step 210 and the next idle duration begins at step 206.

When the maximum time of the time window does not exceed the timeout value at step 216, the method 200 proceeds to step 222. At step 222, storage controller 120 waits for the idle duration to pass the maximum time of the time window. Once the idle duration exceeds the maximum time of the time window, that time window is eliminated from consideration at step 224. In this way, when the storage device 150 continues to remain idle (see step 226), storage controller 120 determines the time window with the next highest number of previous idle durations at step 214. In embodiments with weighted values applied, storage controller 120 reapplies weighted values to the remaining time windows at step 214 when storage device 150 continues to remain idle. Otherwise, when it is determined that storage device 150 has become active, information relating to the current idle duration is stored in step 210 and the process restarts from step 206 when the next idle duration begins.

### EXAMPLE 1

### Adaptive Power-Down Based on Predicted Idle Time (No Weighted Values)

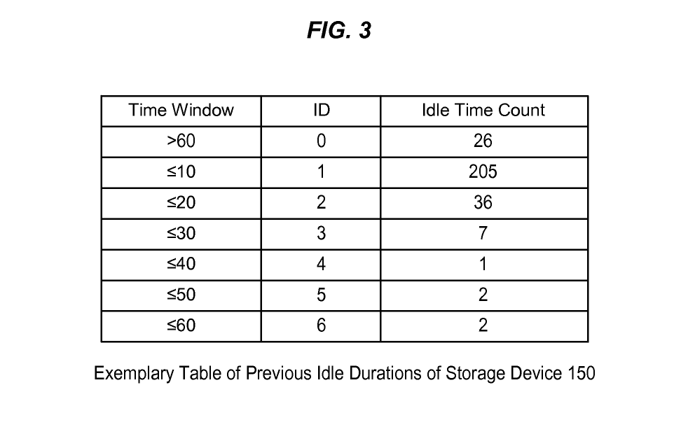

FIG. 3 is an exemplary table illustrating a previous power-down distribution. Assume, for the sake of this embodiment, that a threshold value associated with storage device 150 is set at 50 seconds. As can be seen in FIG. 3, seven time windows have been created and each has a corresponding identification number (ID). Time window 1 has a minimum time of 0 seconds and a maximum time of 10 seconds. Time window 2 has a minimum time greater than 10 seconds and a maximum time of 20 seconds. Time window 3 has a minimum time greater than 20 seconds and a maximum time of 30 seconds. Time window 4 has a minimum time greater than 30 seconds and a maximum time of 40 seconds. Time window 5 has a minimum time greater than 40 seconds and a maximum time of 50 seconds. Time window 6 has a minimum time greater than 50 seconds and a maximum time of 60 seconds. Time window 0 has a minimum time of greater than 60 seconds and an unlimited maximum time.

Further assume for the sake of the embodiment, that the method 200 has been running for some time and that each of the time windows has an associated previous idle count. As seen in FIG. 3, storage device 150 has had 205 previous idle durations that lasted between 0 and 10 seconds. Thus, time window 1 has an idle count of 205. Time window 2 has the second highest number of previous idle durations at 36. Time window 0 has the third highest number of previous idle durations (i.e., durations that lasted longer than 60 seconds) and so on.

A new idle duration is detected and storage controller 120 tracks the idle duration at step 206. Assuming storage device 150 is not active, storage controller 120 identifies the time window (step 214) with the highest number of previous idle durations, which in this case is time window 1 with a count of 205. Next, storage controller 120 determines whether the maximum time of time window 1 (10 seconds) exceeds the timeout value of storage device 150 (50 seconds). Since the maximum of time window 1 does not exceed the timeout value, storage controller 120 waits until the current idle duration crosses 10 seconds and eliminates time window 1 from consideration for the remainder of this idle duration (steps 222-224).

When storage device 150 continues to remain idle, storage controller 120 identifies (at step 214), from the remaining time windows, which time window has the highest number of idle durations. Storage controller 120 identifies time window 2 since it has 36 previous idle durations. Time window 2 has a maximum time of 20 seconds. Since this is still less than the timeout value of 50 seconds, storage controller 120 waits for the current idle duration to cross the maximum time of that time window at step 222. Once the current idle duration crosses 20 seconds, time window 2 is eliminated from consideration (step 224).

Assuming storage device 150 continues to remain idle (step 226), storage controller 120 next identifies time window 0 which has the next highest number of previous idle durations at 26. The maximum time of time window 0 is unlimited, and therefore exceeds the timeout value of 50 seconds. Therefore, storage controller 120 directs storage device 150 to power-down at step 218. In this case, storage device 150 is powered-down almost immediately after the current idle duration crosses the 20 second mark. Therefore, if storage device were to continue to remain idle for a total idle duration of 107 seconds, storage device 150 would be powered-down for approximately 87 seconds. On the other hand, in a fixed-timeout strategy (timeout value of 50 seconds), storage device 150 would have been powered down for only for 57 seconds (i.e., 107-50=57). Therefore, storage controller 120 powers-down storage device 150 earlier than the timeout value (therefore saving unnecessary energy consumption) when it is likely that storage device 150 will remain idle for a longer period of time.

### EXAMPLE 2

### Adaptive Power-Down Based on Predicted Idle Time (Weighted Values Applied)

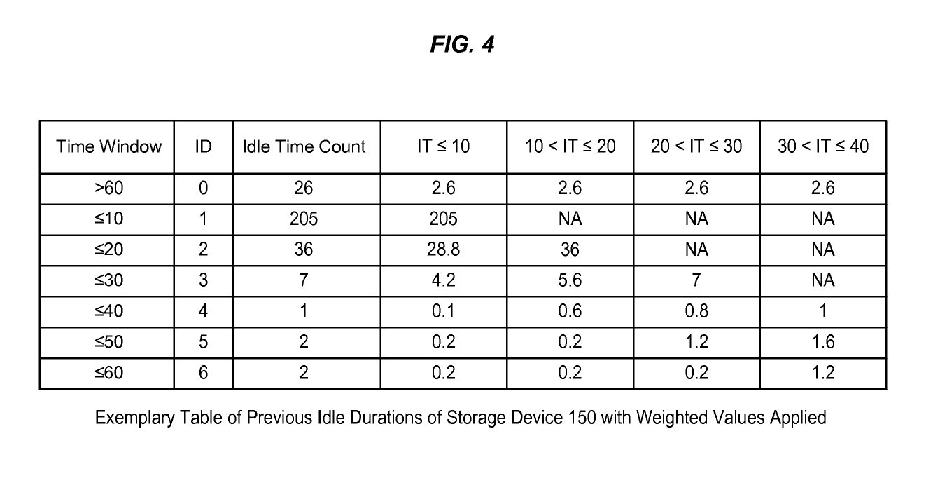

FIG. 4 is an exemplary table illustrating a previous power-down distribution with applied weighted values. Assume a time window and idle count distribution similar to that of FIG. 3 described above. However, as seen in FIG. 4, weighted values are applied to the idle counts based on the current idle duration of storage device 150. As discussed above, weighted values allow storage controller 120 to consider past behavior of storage device 150 and to allow a user and/or storage controller 120 to adjust the adaptability of power-down decisions made by the storage controller 120. In this example, a weighted value of 1 is applied to the time window that includes the current idle duration, a weighted value of 0.8 is applied to the next-closest time window to the current idle duration, a weighted value of 0.6 is applied to the time window after that, and a weighted value of 0.1 is applied to all other time windows. The value of the coefficient that is applied to any given time window is thus based on the proximity of the time window(s) to the current idle duration. It will be appreciated that the coefficients used in FIG. 4 are merely exemplary and that a number of coefficient value(s) and/or combinations of coefficient values may be used by matter of design choice.

In this example, referring to the table of FIG. 4 and the method 200 of FIG. 2, storage controller 120 begins to track a new idle duration of storage device 150 at step 206. Assume again, for the sake of the example that the threshold value is set at 50 seconds. At step 212, storage controller 120 applies weighted values based on the current idle duration of storage device 150. Since at first the idle duration is between 0 and 10 seconds (i.e., idle time (IT)≦10 seconds, see fourth column in FIG. 4), a weighted of 1 is applied to time window 1. Therefore, the idle count of time window 1, which is 205, is multiplied by 1 for a total value of 205. The next closest time window to the current idle duration is time window 2, then time windows 3, 4, 5, 6, and 0, in that order. Therefore the idle count of time window 2 is multiplied by 0.8 for a total value of 28.8 (36*0.8=28.8). The idle count of time window 3 is multiplied by 0.6 for a total value of 4.2 (7*0.6=4.2). The rest of the time windows have an applied weighted value of 0.1 since they are furthest from the current idle duration.

At step 214, storage controller 120 identifies time window 1 as having the highest number of previous idle durations with the applied coefficients, which is 205. At step 216, storage controller 120 determines that the maximum of time window 1 (10 seconds) does not exceed the timeout value (50 seconds). Therefore, storage controller 120 waits for the idle duration to cross the 10 second mark and eliminates time window 1 from future consideration for this idle duration (see steps 222-224).

As storage device 150 remains idle, coefficients are re-applied at step 212. Now, with the current idle duration just over 10 seconds, time window 2 has an applied coefficient of 1, time window 3 has an applied coefficient of 0.8, time window 4 has an applied coefficient of 0.6, and time windows 5, 6, and 0 have an applied coefficient of 0.1 (see “10<(IT)≦20” column in FIG. 4). Furthermore, as discussed above, time window 1 has been eliminated from consideration for this idle duration and thus has an “NA” designation in the column where the current idle duration is greater than 10 seconds and less than 20 seconds. With the coefficients re-applied, storage controller 120 identifies time window 2 as having the highest number of previous idle durations with the applied coefficients, which is 36 (36*1=36), at step 214. Since the maximum of time window 2 (20 seconds) does not exceed the timeout value of 50 seconds, storage controller 120 waits for the current idle duration to cross the 20 second mark and eliminates time window 2 from consideration for this idle duration (see steps 222-224).

As storage device 150 continues to remain idle, coefficients are re-applied at step 212. Now, with the current idle duration just over 20 seconds, time window 3 has an applied weighted value of 1, time window 4 has an applied weighted value of 0.8, time window 5 has an applied weighted value of 0.6, and time windows 6 and 0 have an applied weighted value of 0.1. Time windows 1 and 2 have been eliminated and thus have an “NA” designation for when the current idle time is greater than 20 seconds and less than or equal to 30 seconds. With the coefficients re-applied once more, storage controller 120 identifies time window 3 as having the highest number of previous idle durations with the applied coefficients, which is 7 (7*1=7), at step 214. Since the maximum of time window 3 (30 seconds) does not exceed the timeout value of 50 seconds, storage controller 120 waits for the current idle duration to cross the 30 second mark and eliminates time window 3 from consideration for this idle duration (see steps 222-224).

Again, as storage device 150 continues to remain idle, coefficients are re-applied at step 212. Now, with the current idle duration just over 30 seconds, time window 4 has an applied weighted value of 1, time window 5 has an applied weighted value of 0.8, time window 6 has an applied weighted value of 0.6, and time window 0 has an applied weighted value of 0.1. Time windows 1, 2, and 3 have an “NA” designation for the current idle duration. With the coefficients again re-applied, storage controller 120 identifies time window 0 as having the highest number of previous idle durations with the applied coefficients, which is 2.6 (26*0.1=2.6), at step 214. Since the maximum of time window 0 exceeds the timeout value of 50 seconds, storage controller 120 directs storage device 150 to power-down at step 218.

In this case, storage device 150 is powered-down almost immediately after the current idle duration crosses the 30 second mark. Therefore, if storage device were to continue to remain idle for a total idle duration of 107 seconds, storage device 150 would be powered-down for approximately 77 seconds. Thus, the applied weighted values may cause storage controller 120 to more conservatively power-down storage device 150 which may improve the long term health of storage device 150 over techniques which cause frequent spin-down and spin-up of the drive. Also, weighted values can help reduce false power-downs (i.e., powering-down storage device 150 right before it becomes active) but retain the benefit of the adaptive power-down based on the previous idle durations of storage device 150. And, the weighted values also outperform the fixed-timeout technique, which, as discussed above would have powered-down storage device 150 for just 57 seconds. Although FIGS. 3 and 4 illustrate seven time windows that increment by 10 seconds, one skilled in the art will recognize that the number of time windows and/or time window lengths are merely a matter of design choice.

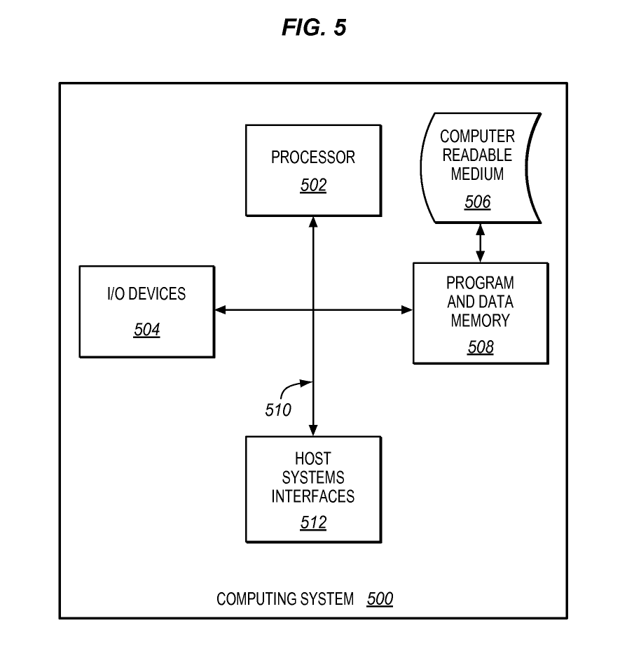

Embodiments of the invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 5 illustrates a computing system 500 in which a computer readable medium 506 provides instructions for performing any of the methods disclosed herein.

Furthermore, embodiments of the invention can take the form of a computer program product accessible from the computer readable medium 506 providing program code for use by or in connection with a computer or any instruction execution system. For the purposes of this description, the computer readable medium 506 can be any apparatus that can tangibly store the program for use by or in connection with the instruction execution system, apparatus, or device, including the computing system 500.

The medium 506 can be any tangible electronic, magnetic, optical, electromagnetic, infrared, or semiconductor system (or apparatus or device). Examples of a computer readable medium 506 include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The computing system 500, suitable for storing and/or executing program code, can include one or more processors 502 coupled directly or indirectly to memory 508 through a system bus 510. The memory 508 can include local memory employed during actual execution of the program code, bulk storage, and cache memories which provide temporary storage of at least some program code in order to reduce the number of times code is retrieved from bulk storage during execution. Input/output or I/O devices 504 (including but not limited to keyboards, displays, pointing devices, etc.) can be coupled to the system either directly or through intervening I/O controllers. Network adapters may also be coupled to the system to enable the data processing system to become coupled to other data processing systems, such as through host systems interfaces 512, or remote printers or storage devices through intervening private or public networks. Modems, cable modem and Ethernet cards are just a few of the currently available types of network adapters.

What is claimed is:

1. A storage controller, comprising:
an interface operable to communicatively couple the storage controller with a disk drive; and
a processor operable to:
track idle durations of the disk drive;
when an idle duration ends, associate the idle duration with a time window that includes the idle duration, the time window being one of a plurality of non-overlapping time windows that each are associated with a number of previous idle durations of the disk drive;
upon detection of a current idle duration, identify a time window with a highest number of previous idle durations of the disk drive;
determine whether a maximum time associated with the identified time window exceeds a predetermined threshold; and
power-down the disk drive when the maximum time exceeds the predetermined threshold.

2. The storage controller of claim 1, the processor further operable to:
multiply the number of previous idle durations associated with each time window with a weighted value, the weighted value based on the proximity of each time window to the current idle duration of the disk drive.

3. The storage controller of claim 2, the processor further operable to:
in response to a determination that the maximum time does not exceed the predetermined threshold:
wait until the current idle duration exceeds the maximum time;
re-multiply the number of previous idle durations associated with each time window with an updated weighted value based on the proximity of each time window to the current idle duration of the disk drive; and
identify another time window with a next highest number of previous idle durations.

4. The storage controller of claim 1, the processor further operable to:
in response to a determination that the maximum time does not exceed the predetermined threshold:
wait until the current idle duration exceeds the maximum time;
identify another time window with a next highest number of previous idle durations; and
power-down the disk drive when a maximum time of the identified another time window exceeds the timeout value.

5. The storage controller of claim 1, the processor further operable to:
increment the number of previous idle duration of the identified time window when the disk drive is powered-down.

6. A method, comprising:
tracking idle durations of a disk drive;
when an idle duration ends, associating the idle duration with a time window that includes the idle duration, the time window being one of a plurality of non-overlapping time windows that each are associated with a number of previous idle durations of the disk drive;
upon detection of a current idle duration, identifying a time window with a highest number of previous idle durations of the disk drive;
determining whether a maximum time associated with the identified time window exceeds a predetermined threshold; and
powering-down the disk drive when the maximum time exceeds the predetermined threshold.

7. The method of claim 6, further comprising:
multiplying the number of previous idle durations associated with each time window with a weighted value, the weighted value based on the proximity of each time window to the current idle duration of the disk drive.

8. The method of claim 7, further comprising:
in response to a determination that the maximum time does not exceed the predetermined threshold:
waiting until the current idle duration exceeds the maximum time;
re-multiplying the number of previous idle durations associated with each time window with an updated weighted value based on the proximity of each time window to the current idle duration of the disk drive; and
identifying another time window with a next highest number of previous idle durations.

9. The method of claim 6, further comprising:
in response to a determination that the maximum time does not exceed the predetermined threshold:
waiting until the current idle duration exceeds the maximum time;
identifying another time window with a next highest number of previous idle durations; and
powering-down the disk drive when a maximum time of the identified another time window exceeds the timeout value.

10. The method of claim 6, further comprising:
incrementing the number of previous idle duration of the identified time window when the disk drive is powered-down.

11. A non-transitory computer readable medium embodying programmed instructions which, when executed by a processor, are operable to perform the steps of:
tracking idle durations of a disk drive;
when an idle duration ends, associating the idle duration with a time window that includes the idle duration, the time window being one of a plurality of non-overlapping time windows that each are associated with a number of previous idle durations of the disk drive;
upon detection of a current idle duration, identifying a time window with a highest number of previous idle durations of the disk drive;
determining whether a maximum time associated with the identified time window exceeds a predetermined threshold; and
powering-down the disk drive when the maximum time exceeds the predetermined threshold.

12. The medium of claim 11, further comprising:
multiplying the number of previous idle durations associated with each time window with a weighted value, the weighted value based on the proximity of each time window to the current idle duration of the disk drive.

13. The medium of claim 12, further comprising:
in response to a determination that the maximum time does not exceed the predetermined threshold:
waiting until the current idle duration exceeds the maximum time;
re-multiplying the number of previous idle durations associated with each time window with an updated weighted value based on the proximity of each time window to the current idle duration of the disk drive; and
identifying another time window with a next highest number of previous idle durations.

14. The medium of claim 11, further comprising:
in response to a determination that the maximum time does not exceed the predetermined threshold:
waiting until the current idle duration exceeds the maximum time;
identifying another time window with a next highest number of previous idle durations; and
powering-down the disk drive when a maximum time of the identified another time window exceeds the timeout value.

15. The medium of claim 11, further comprising:
incrementing the number of previous idle duration of the identified time window when the disk drive is powered-down.
